(19) United States
(12) Patent Application Publication
(10) Pub. No.: US 2008/0056171 A1
(43) Pub. Date: Mar. 6, 2008

(54) ARRANGEMENT AND METHOD FOR CELLULAR DATA TRANSMISSION

(76) Inventor: Ali S. Khayrallah, Cary, NC (US)

Correspondence Address: ERICSSON INC., 6300 LEGACY DRIVE, M/S EVR 1-C-11, PLANO, TX, 75024, US

(21) Appl. No.: 11/465,977

(22) Filed: Aug. 21, 2006

(51) Int. Cl. H04Q 7/00

(52) U.S. Cl. 370/314

(57) ABSTRACT

An arrangement, control unit, and method in a cellular telecommunication system for allocating packets in a packet data stream to different base stations for transmission to a mobile terminal. The control unit receives the packet data stream in a main queue and identifies a plurality of base stations having sufficient signal strength to communicate with the mobile terminal. A data splitter splits the data stream into a number of sub-streams containing different data packets from the packet data stream. The sub-streams are buffered in a number of sub-queues, each of which is connected to a different base station. Packets are allocated to the sub-queues to maintain equal numbers of packets in each sub-queue, or to maintain a specified quality of service level for each sub-stream. The base stations independently transmit their sub-streams to the mobile terminal. Error-control coding may be applied to the packets to enhance macro diversity benefits.

### CROSS-REFERENCE TO RELATED APPLICATIONS

NOT APPLICABLE

### STATEMENT REGARDING FEDERALLY SPONSORED REASEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

This invention relates to cellular telecommunication systems. More particularly, and not by way of limitation, the invention is directed to an arrangement and method for splitting a data stream and utilizing multiple base stations to transmit multiple data sub-streams to a mobile terminal.

In the WCDMA cellular telecommunication system, it is possible to connect a mobile terminal in circuit-switched mode to multiple base stations simultaneously, in what is referred to as soft-handoff. Basically, the same information is sent to the terminal from two or more base stations. The terminal receiver combines the multiple signals to retrieve the information. The quality of the link is improved by this diversity of signals, and the benefits are well understood.

High-Speed Downlink Packet Access (HSDPA) is a mobile telephony protocol that extends WCDMA to provide higher data capacity (up to 14.4 Mbit/s in the downlink). HSDPA is an evolution of the WCDMA standard, designed to increase the available data rate by a factor of five or more. HSDPA defines a new WCDMA channel, the High-Speed Downlink Shared Channel (HS-DSCH) that enables packet data transmission on the downlink (base station to mobile terminal). The primary mode of operation is with Automatic Repeat Request (ARQ), whereby packets are acknowledged and retransmissions are used to ensure successful reception of previously failed packets. Over the development of HSDPA, it has become apparent that a straightforward extension of the soft handoff idea to ARQ operation is problematic. In particular, the signaling burden on the system infrastructure would be very high. Currently, therefore, HSDPA uses a single connection to the terminal. Thus, the benefit of macro diversity is lost, when it could be a crucial ingredient to enabling high rate packet data coverage.

What is needed in the art is an arrangement and method for enabling multiple base stations to transmit multiple data sub-streams to a mobile terminal while minimizing the signaling burden on the system infrastructure. The present invention provides such an arrangement and method.

### BRIEF SUMMARY OF THE INVENTION

The present invention provides an arrangement, control unit, and method for transmitting packet data to a mobile terminal from multiple transmitting base stations in a cellular telecommunication system. The invention seamlessly splits a data stream into multiple sub-streams distributed among multiple base stations. Each sub-stream is sent to a different base station, and each base station treats its sub-stream locally, dealing with the terminal independently of other base stations. Since central control is limited, issues of resource allocation, scheduling, ARQ, and the like are all handled locally in the base stations.

The invention provides several benefits. The invention allows better resource allocation without burdening the system with excessive signaling to coordinate the multiple connections. The invention also provides better load balancing among base stations, macro diversity gain, and better coverage at high data rates. The changes to existing networks required to implement the invention are relatively minor, and do not affect the base station. At the terminal, the invention does not require a special receiver. However, if the receiver has advanced capabilities such as interference suppression with one or multiple antennas, then those capabilities can be fully exploited in conjunction with the invention. The invention also provides new capabilities for controlling user priority. That is, a data stream can be given a certain priority on all connecting cells, or the priority can be varied for different base stations, depending on traffic loading for instance.

Thus, in one aspect, the present invention is directed to an arrangement in a packet-switched cellular telecommunication system for transmitting a packet data stream to a mobile terminal. The arrangement includes a data splitter for splitting the packet data stream into a plurality of sub-streams, each of which contains different data packets from the packet data stream; and means for transmitting each of the sub-streams to a different base station in communication with the mobile terminal for further transmission to the mobile terminal.

In another aspect, the present invention is directed to a method of allocating packets in a packet data stream to different base stations for transmission to a mobile terminal. The method includes the steps of receiving the packet data stream in a control unit; identifying a plurality of base stations having sufficient signal strength to communicate with the mobile terminal; and splitting the packet data stream into a number of sub-streams equal to or less than the plurality of base stations, each of the sub-streams containing different data packets from the packet data stream. The method also includes transmitting each of the sub-streams to an associated one of the plurality of base stations; determining a transmission rate for each of the plurality of base stations; and allocating packets to each of the sub-streams based upon the determined transmission rate for the associated base station.

In another aspect, the present invention is directed to a control unit in a packet-switched cellular telecommunication system for allocating packets in a packet data stream to different base stations for transmission to a mobile terminal. The control unit includes a main queue for receiving the packet data stream from the cellular telecommunication system; means for identifying a plurality of base stations having sufficient signal strength to communicate with the mobile terminal; and a data splitter for splitting the packet data stream into a number of sub-streams equal to or less than the plurality of base stations, each of the sub-streams containing different data packets from the packet data stream. The control unit also includes means for transmitting each of the sub-streams to an associated one of the plurality of base stations for transmission to the mobile terminal.

### BRIEF DESCRIPTION OF THE SEVERAL VIEWS OF THE DRAWING

In the following, the essential features of the invention will be described in detail by showing preferred embodiments, with reference to the attached figures in which:

FIG. 1 (Prior Art) is a simplified block diagram of an existing network configuration for transmitting data to and from a mobile station utilizing HSDPA;

FIG. 2 is a simplified block diagram of an exemplary embodiment of the arrangement of the present invention;

FIG. 3 is a simplified block diagram of a data splitter inserted between a main data queue and a plurality of data sub-queues in an exemplary embodiment of the arrangement and control unit of the present invention; and

FIG. 4 is a flow chart illustrating the steps of an exemplary embodiment of the method of the present invention.

### DETAILED DESCRIPTION OF THE INVENTION

The present invention provides some of the benefits of macro diversity by splitting the packet stream into a number of sub-streams distributed among a corresponding number of base stations. While each individual packet belongs to a single sub-stream, and does not get a direct macro diversity benefit, the whole stream does get a macro diversity benefit, which is seen by the application that needs the information. A variant of the method also captures macro diversity at the information level via error-control coding and interleaving over packets.

Although the method is applicable in general to any packet-switched cellular system, such as WIMAX, Super 3G or 4G, the exemplary description herein utilizes the WCDMA/HSPA system as an example.

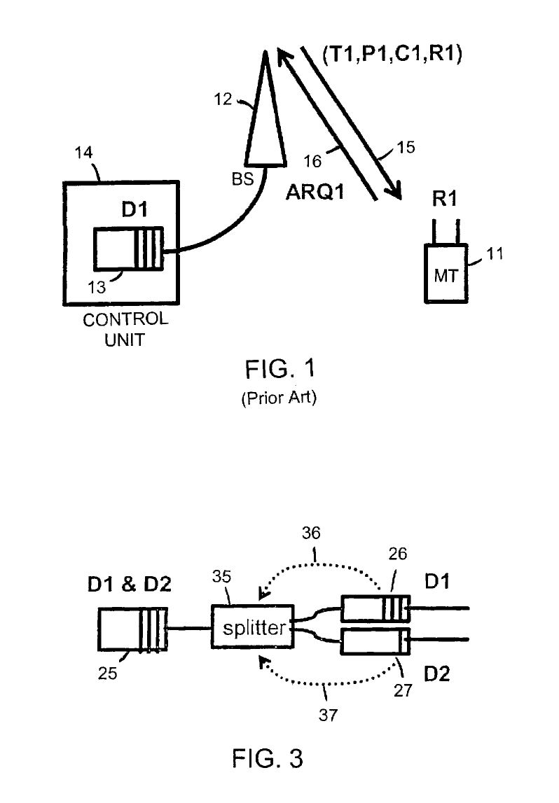

FIG. 1 is a simplified block diagram of an existing network configuration for transmitting data to and from a mobile station utilizing HSDPA. A mobile terminal (MT) 11 is connected to the system via a single base station (BS) 12. The system is informed of the capabilities of the terminal, which include the modulation and coding schemes supported by the terminal. A data stream D1 arrives and is intended for the terminal. In this example, the data are placed in a queue 13 at a control unit 14. The data are transmitted to the BS as packets, which are transmitted to the mobile terminal over a wireless downlink connection represented by the arrow 15. The BS has estimates of the effective quality of the downlink connection to all its terminals, and decides how to allocate its resources to each connection. The quality measure may be, for example, an estimate of the signal-to-noise ratio (SNR) at the terminal, which is communicated directly or via some other parameter to the BS on the uplink connection represented by the arrow 16.

The BS allocates its resources to the competing terminals by scheduling their packets and assigning them time slots T1. When its turn comes, a packet is transmitted with a certain fraction of the total power P1, over a number of spreading codes C1, and using a certain coding rate R1. The coding rate is chosen to achieve a certain quality, for example 10% or 1% block error rate (BLER). At the terminal receiver, certain blocks are received incorrectly, and the terminal informs the BS via an ARQ protocol. Retransmissions or complementary transmissions are scheduled accordingly. Eventually, all the data in the stream is received successfully. The terminal receives the data stream at a nominal rate equal to R1. The effective rate is a fraction of R1 that depends on the target quality, accounting for retransmissions. For instance, for 10% BLER, the effective rate is approximately 0.9 R1.

The scheduling procedure may be a straightforward round-robin scheme, or a greedy scheme, which schedules the terminal with the best connection, or a scheme somewhere in between the two. The scheduling procedure may also incorporate service quality into its scheduling decisions, and give different data streams different priorities. Differentiated service assumes that different streams are assigned different priorities by the system, and that the BS is informed accordingly. In general, resource allocation is handled locally at each base station, with minimal coordination among base stations.

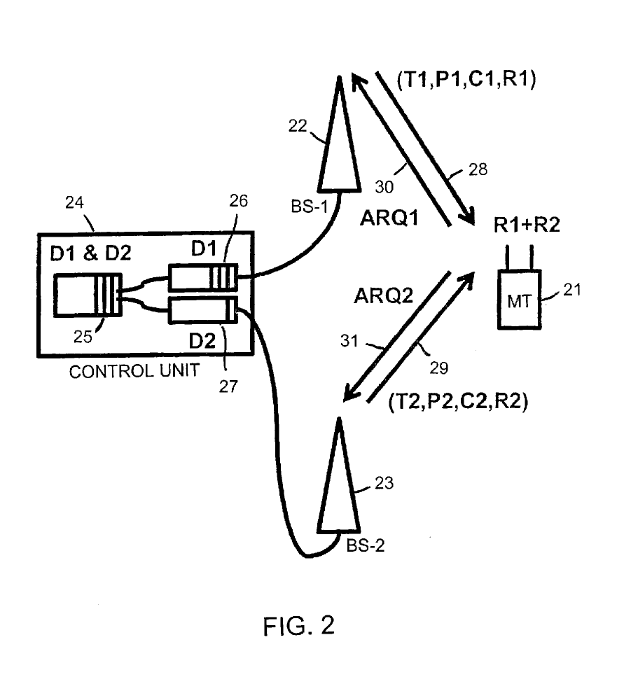

FIG. 2 is a simplified block diagram of an exemplary embodiment of the arrangement of the present invention. In this example, a mobile terminal 21 is simultaneously connected to two base stations, BS-1 22 and BS-2 23. At a control unit 24, a main queue (D1 & D2) 25 is split into two sub-queues D1 26 and D2 27. Each sub-queue is connected to a different one of the base stations 22 and 23. The mechanism for splitting the data over the sub-queues is described below in connection with FIG. 3. The control unit may be a base station controller, which includes other known functional units such as a unit for identifying a plurality of base stations having sufficient signal strength to communicate with the mobile terminal, and a unit for determining the traffic load on each base station.

BS-1 transmits data packets from sub-queue D1 to the mobile terminal over a wireless downlink connection represented by the arrow 28, while BS-2 transmits data packets from sub-queue D2 to the mobile terminal over a wireless downlink connection represented by the arrow 29. As before, BS-1 22 decides the allocation of time slots T1, power P1, spreading codes C1, and coding rate R1. Similarly, BS-2 23 decides the allocation of time slots T2, power P2, spreading codes C2, and coding rate R2. The decisions are made locally in each base station, without any explicit coordination between base stations. The terminal 21 must receive both signals and process them. The terminal also signals to each base station separately via ARQ processes ARQ1 and ARQ2 on uplink connections 30 and 31. Most importantly, the terminal receives the data stream at a nominal rate equal to R1+R2.

FIG. 3 is a simplified block diagram of a data splitter 35 inserted between the main data queue 25 and the data sub-queues D1 26 and D2 27 in an exemplary embodiment of the arrangement and control unit of the present invention. The data splitter is the only new function needed to implement the present invention at the control unit. Each sub-queue has a number of packets waiting to be sent to the sub-queue's respective base station. The number of queued packets in each queue reflects the effective transmission rate by the particular base station connected to the sub-queue. Feedback to the data splitter regarding the number of packets in each sub-queue (illustrated by dotted arrows 36 and 37) enables the splitter to regulate the flow of data by directing more data packets to the sub-queue currently containing fewer packets.

In the single-connection scenario illustrated in FIG. 1, the system may allocate a quality of service (QoS) to the data stream. Basically, a higher quality of service ensures that the data reaches the user faster. The system provides various QoS levels by allocating different levels of resources to the data stream in terms of scheduling, power, spreading codes, and the like.

With multiple connections, the present invention may impose the same QoS on all sub-streams, or may vary the QoS per sub-stream. This may be done to help with load balancing on different base stations. That is, the quality requirements may be relaxed for a base station with a high load. In particular, the system may designate a primary connection for which the QoS is maintained. One or more secondary base stations may act as overflow connections, where the quality of service is relaxed. The primary base station may change over time, so that the primary base station is the one for which the load and the connection to the terminal enable it to maintain the required quality of service.

In the prior art soft handoff, each bit of information is repeated in the signals sent from different base stations. Consequently, when the terminal receiver combines the multiple signals, each bit of information gets the benefit of macro diversity. In the present invention, however, each bit of information is mapped onto a single packet, which is transmitted from only one of the multiple base stations. Thus, individual bits do not necessarily see the benefit of macro diversity at the bit level. However, the whole stream does get a macro diversity benefit, which is seen by the application that needs the information. This is reflected in a higher effective data rate, which translates into less delay.

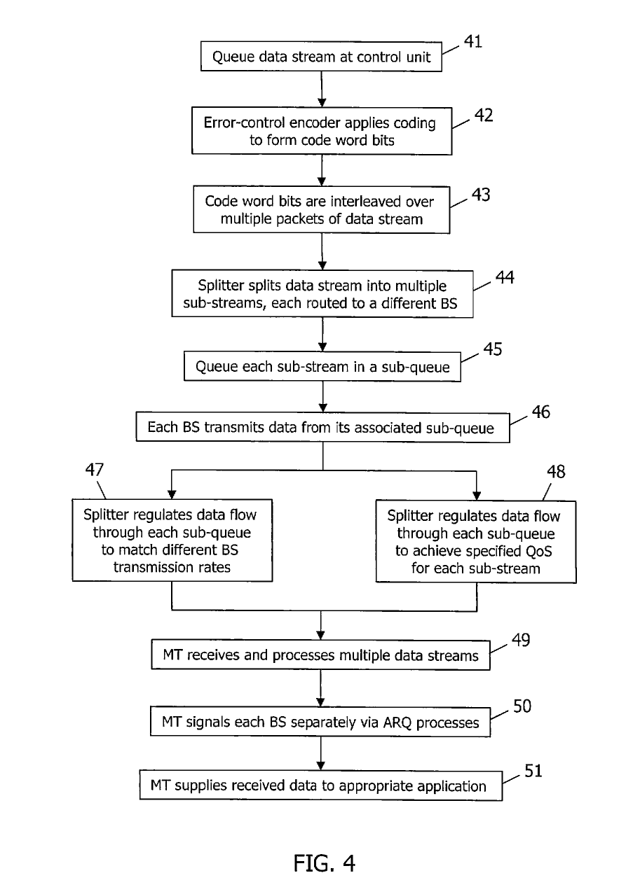

FIG. 4 is a flow chart illustrating the steps of an exemplary embodiment of the method of the present invention. In this embodiment, the present invention may also capture the entire macro diversity effect at the information bit level by utilizing error-control coding and interleaving over packets. At step 41, the control unit 24 queues the data stream in the main queue 25. A block of information bits is then fed into an error-control encoder, which applies error-control encoding at step 42 to form a code word. Any error-control coding scheme may be utilized for this purpose, including turbo codes, convolutional codes, low-density parity check codes, and the like. At step 43, the bits of the code word are then interleaved over multiple packets of the data stream. At step 44, the data splitter 35 splits the data stream into multiple sub-streams, each routed to a different BS. When the packets go through the splitter, there is a natural adaptive multiplexing that occurs. That is, since a good connection tends to take in more packets, then if most or all of the packets that include the bits of a certain code word go on the good connection, the code word is received with problem. If there is not a particularly good connection, then the packets tend to be distributed evenly over the sub-streams, and this provides a diversity effect.

At step 45, the control unit 24 queues each sub-stream in a sub-queue 26, 27. At step 46, each BS transmits data from its associated sub-queue to the MT 21. The method may then move to step 47 where the data splitter 35 regulates the data flow through each sub-queue to match the different BS transmission rates, without regard to any QoS level. Alternatively, if a QoS level has been specified for one or more sub-streams, the method may then move to step 48 where the data splitter regulates the data flow through each sub-queue to achieve the specified QoS for each sub-stream. At step 49, the MT receives and processes the multiple data streams. At step 50, the MT signals each BS separately via ARQ processes. At step 51, the MT supplies the received data to an appropriate application.

Many advanced receiver structures have been proposed for CDMA systems that incorporate interference suppression capabilities. In the present invention, the MT 21 is connected to multiple base stations, and therefore it is advantageous to equip the MT with an advanced receiver such as a G-RAKE receiver. The G-RAKE receiver can suppress own-cell and other-cell interference with reasonable complexity. The mobile terminal has to compute certain parameters for each received signal, such as channel estimates. Those channel estimates are not only useful for demodulating the corresponding signal, but they are also useful for modeling that same signal as an interferer while demodulating another signal. This can be readily done in the G-RAKE receiver. Also, the G-RAKE receiver works with any number of receive antennas. Having more antennas greatly improves the suppression of own-cell interference and other-cell interference. Explicit knowledge about different signals can be incorporated to improve the suppression capability of the receiver.

Other techniques such as interference subtraction, joint demodulation, and the like, can also be adapted to the scenario of multiple connections.

Although preferred embodiments of the present invention have been illustrated in the accompanying drawings and described in the foregoing Detailed Description, it is understood that the invention is not limited to the embodiments disclosed, but is capable of numerous rearrangements, modifications, and substitutions without departing from the scope of the invention. The specification contemplates any all modifications that fall within the scope of the invention defined by the following claims.

What is claimed is:

1. An arrangement in a packet-switched cellular telecommunication system for transmitting a packet data stream to a mobile terminal, said arrangement comprising:
a data splitter for splitting the packet data stream into a plurality of sub-streams, each of said sub-streams containing different data packets from the packet data stream; and
means for transmitting each of the sub-streams to a different base station in communication with the mobile terminal for further transmission to the mobile terminal.

2. The arrangement according to claim 1, further comprising means within each of the base stations for making resource allocation decisions locally.

3. The arrangement according to claim 1, further comprising means within each of the base stations and the mobile terminal for exchanging Automatic Repeat Request (ARQ) signaling independent of the other base stations.

4. The arrangement according to claim 1, wherein the data splitter is located in a control unit, said control unit also including:
a main queue having an input connected to a communications network for receiving the data stream and an output connected to an input of the data splitter, said main queue queuing the packet data stream and providing the packet data stream to the data splitter; and
a plurality of sub-queues, each sub-queue having an input connected to an output of the data splitter for receiving one of the sub-streams from the data splitter, each of said sub-queues having an output connected to a connection to one of the different base stations for transmitting the sub-stream to the connected base station.

5. The arrangement according to claim 4, wherein the control unit also includes:
a feedback unit for providing feedback information from the sub-queues to the data splitter, said feedback information including the number of packets in each sub-queue;
wherein the data splitter includes a packet flow regulator for allocating packets to each of the sub-queues based upon the feedback information.

6. The arrangement according to claim 5, wherein the control unit also includes means for designating a quality of service level to be maintained on all sub-streams, wherein the feedback information includes information regarding a traffic load on each base station, and the packet flow regulator allocates packets to each of the sub-queues based upon the feedback information.

7. The arrangement according to claim 5, wherein the control unit also includes means for designating a different quality of service level to be maintained on each sub-stream, wherein the feedback information includes information regarding a traffic load on each base station, and the packet flow regulator allocates packets to each of the sub-queues based upon the feedback information.

8. The arrangement according to claim 7, wherein one of the base station connections is designated as the primary connection, and one or more of the other connections are designated as secondary connections, wherein the packet flow regulator allocates packets to each of the sub-queues to maintain a designated quality of service for the primary connection while allowing the quality of service for the secondary connections to vary according to the traffic load on each base station.

9. The arrangement according to claim 5, wherein the control unit also includes an error-control encoder between the main queue and the data splitter for receiving a block of information bits from the main queue and applying error-control encoding to the bits to form a code word, wherein the bits of the code word are interleaved over multiple packets of the data stream.

10. The arrangement according to claim 9, wherein the data splitter sends packets containing different bits of the code word to different sub-streams, thus causing different bits of the code word to be transmitted to the mobile terminal by different base stations, wherein the data received by the mobile terminal benefits from a diversity effect.

11. The arrangement according to claim 1, further comprising an interference-suppression receiver in the mobile terminal, said receiver including means for suppressing own-cell interference and other-cell interference based on knowledge of multiple received signals.

12. The arrangement according to claim 11, wherein the receiver is a G-RAKE receiver and the means for suppressing own-cell interference and other-cell interference includes:
a channel estimator for calculating a channel estimate for demodulating a received signal;
means for modeling the received signal as an interfering signal based on the channel estimate; and
means for using the modeled interfering signal to reduce interference while demodulating a second signal.

13. The arrangement according to claim 12, wherein the mobile station includes multiple receive antennas connected to the G-RAKE receiver.

14. In a packet-switched cellular telecommunication system, a method of allocating packets in a packet data stream to different base stations for transmission to a mobile terminal, said method comprising:
receiving the packet data stream in a control unit;
identifying a plurality of base stations having sufficient signal strength to communicate with the mobile terminal;
splitting the packet data stream into a number of sub-streams equal to or less than the plurality of base stations, each of said sub-streams containing different data packets from the packet data stream;
transmitting each of the sub-streams to an associated one of the plurality of base stations;
determining a transmission rate for each of the plurality of base stations; and
allocating packets to each of the sub-streams based upon the determined transmission rate for the associated base station.

15. The method according to claim 14, wherein the step of determining a transmission rate for each of the plurality of base stations includes:
queuing each of the sub-streams in a sub-queue having a connection to an associated base station; and
determining the transmission rate for each of the plurality of base stations by detecting the number of data packets remaining in each sub-queue.

16. The method according to claim 15, wherein the step of allocating packets to each of the sub-streams includes allocating packets to each of the sub-streams to maintain an equal number of packets in each sub-queue.

17. The method according to claim 15, wherein the step of allocating packets to each of the sub-streams includes allocating packets to each of the sub-streams to maintain a specified quality of service level for each sub-stream.

18. The method according to claim 15, wherein the step of allocating packets to each of the sub-streams includes allocating packets to each of the sub-streams to maintain a specified quality of service level for a primary sub-stream while allowing the quality of service for other sub-streams to vary.

19. A control unit in a packet-switched cellular telecommunication system for allocating packets in a packet data stream to different base stations for transmission to a mobile terminal, said control unit comprising:
a main queue for receiving the packet data stream from the cellular telecommunication system;
means for identifying a plurality of base stations having sufficient signal strength to communicate with the mobile terminal;
a data splitter for splitting the packet data stream into a number of sub-streams equal to or less than the plurality of base stations, each of said sub-streams containing different data packets from the packet data stream; and
means for transmitting each of the sub-streams to an associated one of the plurality of base stations for transmission to the mobile terminal.

20. The control unit according to claim 19, further comprising:
a plurality of sub-queues for queuing the sub-streams prior to transmission to the plurality of base stations; and
a feedback unit for providing feedback information from the sub-queues to the data splitter, said feedback information including the number of packets in each sub-queue;
wherein the data splitter includes a packet flow regulator for allocating packets to each of the sub-queues based upon the feedback information.

21. The control unit according to claim 20, further comprising:
means for designating a quality of service level to be maintained on all sub-streams, wherein the feedback information includes information regarding a traffic load on each base station, and the packet flow regulator allocates packets to each of the sub-queues based upon the feedback information.

22. The control unit according to claim 20, further comprising:
means for designating a different quality of service level to be maintained on each sub-stream, wherein the feedback information includes information regarding a traffic load on each base station, and the packet flow regulator allocates packets to each of the sub-queues based upon the feedback information.

23. The control unit according to claim 19, further comprising:
an error-control encoder between the main queue and the data splitter for receiving a block of information bits from the main queue and applying error-control encoding to the bits to form a code word, wherein the bits of the code word are interleaved over multiple packets of the data stream.

24. The control unit according to claim 23, wherein the data splitter sends packets containing different bits of the code word to different sub-streams, thus causing different bits of the code word to be transmitted to the mobile terminal by different base stations, wherein the data received by the mobile terminal benefits from a diversity effect.
